(19) United States
(12) Patent Application Publication
(10) Pub. No.: US 2006/0278282 A1
(43) Pub. Date: Dec. 14, 2006

(54) Vacuum unit and method for producing a filter for a vacuum unit

(75) Inventors: Shigekazu Nagai, Adachi-ku (JP); Akio Saitoh, Kawaguchi-shi (JP); Bao Xiao Yan, Moriya-shi (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: SMC Kabushiki Kaisha, Tokyo (JP)

(21) Appl. No.: 11/447,026

(22) Filed: Jun. 6, 2006

(30) Foreign Application Priority Data
Jun. 10, 2005 (JP) 2005-170982

(51) Int. Cl. E03B 5/00; B29C 71/00

(52) U.S. Cl. 137/565.23; 264/234

(57) ABSTRACT

A main body section is provided with a filter for removing dust or the like contained in a pressure fluid, and a silencer for reducing an exhaust sound produced when pressure fluid is discharged from an ejector, which functions as a vacuum-generating mechanism. The filter is formed with a substantially elongated circular cross section having a pair of circular arc sections. Further, the filter is formed in a two-layered structure, composed of an inner layer and an outer layer, obtained by winding fiber materials having different material qualities respectively.

### BACKGROUND OF THE INVENTION

1. Field of the Invention

The present invention relates to a vacuum unit for supplying negative pressure to a working apparatus such as a suction pad, and to a method for producing a filter used in such a vacuum unit. In particular, the present invention relates to a vacuum unit provided with a solenoid-operated valve section capable of switching between supply and cutoff of a negative pressure, and to a method for producing a filter used in the vacuum unit.

2. Description of the Related Art

A vacuum unit, which can be used, for example, as a positioning means and a transport means for a workpiece, has been hitherto known. The vacuum unit is operated such that a suction means, such as a suction pad, is connected to a main unit body, and the workpiece is attracted by the suction means under action of a negative pressure supplied from the main unit body. The workpiece is displaced and transported while remaining in a state of attraction, and the workpiece is disengaged at a predetermined position by releasing the workpiece.

The present applicant has proposed a vacuum unit provided as a unit comprising a main unit body, a vacuum-generating mechanism generating the negative pressure, and a pressure switch for switching an attraction state of a suction means. In this vacuum unit, pressure fluid is supplied to the main unit body. Negative pressure is generated by introducing pressure fluid from the main unit body into the vacuum-generating mechanism, whereupon the negative pressure is supplied to the suction means. During this process, pressure fluid passes through a filter provided in the main unit body. Accordingly, dust or the like, which is contained in the pressure fluid, is removed. Further, a silencer, which reduces exhaust sound when the pressure fluid is discharged, is provided in a discharge port through which the pressure fluid is discharged to the outside (see Japanese Laid-Open Patent Publication No. 11-114862).

In general, in many cases, a plurality of the aforementioned vacuum units are arranged in parallel. However, when the vacuum units are arranged in such an aligned manner, the widthwise dimension is increased. Therefore, it is preferable for the widthwise dimension of each individual vacuum unit to be reduced, thereby enabling the widthwise dimension to be decreased when the vacuum units are arranged in parallel.

Further, the number of constitutive parts of the vacuum unit should preferably be reduced in order to improve assembly operations and to reduce the production cost of the vacuum units.

### SUMMARY OF THE INVENTION

A general object of the present invention is to provide a vacuum unit and a method for producing a filter used in the vacuum unit, in which the number of parts is reduced so that production costs can be reduced, assembly operations are improved, and a compact size of the vacuum unit can be realized.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view illustrating an appearance of a vacuum unit according to an embodiment of the present invention;

FIG. 2 is a vertical sectional view illustrating the vacuum unit shown-in FIG. 1;

FIG. 3 is a partial exploded perspective view illustrating a state in which a filter is removed from the vacuum unit shown in FIG. 1;

FIG. 4 is a vertical sectional view illustrating individually the filter shown in FIG. 3; and

FIG. 5 is schematic view of production steps carried out when the filter shown in FIG. 4 is produced.

### DESCRIPTION OF THE PREFERRED EMBODIMENTS

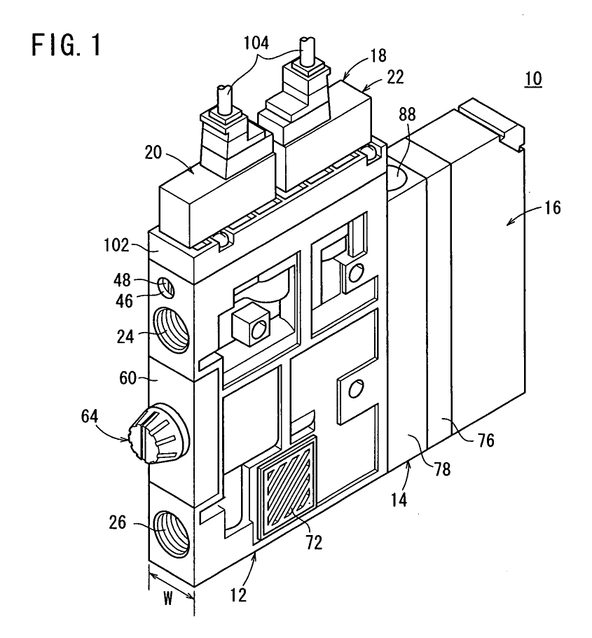

With reference to FIG. 1, reference numeral 10 indicates a vacuum unit according to an embodiment of the present invention.

As shown in FIGS. 1 to 3, the vacuum unit 10 comprises a main body section 12, which is composed of a resin material, an ejector 14 connected to a side portion of the main body section 12 and which functions as a vacuum-generating mechanism, a vacuum switch section 16 that detects the pressure state of the ejector 14, and a solenoid-operated valve section 22 provided on an upper portion of the main body section 12 and which has a supplying pilot valve (supplying directional control valve) 18 and a vacuum-breaking pilot valve (vacuum-breaking directional control valve) 20.

A supply port (pressure fluid-supplying port) 24 which supplies the pressure fluid (for example, compressed air) to the ejector 14, and a vacuum port 26 which is separated from the supply port 24 by a predetermined distance, and to which the negative pressure generated by the ejector 14 is supplied, are formed on a side surface of the main body section 12. An unillustrated suction pad is connected to the vacuum port 26 via a tube or the like.

A supply passage 28, which establishes communication between the supply port 24 and the ejector 14, is formed in the main body section 12. A supply valve 30, which switches between supply and cutoff of the pressure fluid with respect to the ejector 14, is arranged in a first installation hole 32 disposed at an intermediate position of the supply passage 28. A breaker valve 36, which releases the vacuum port 26 from a vacuum state, is provided in a second installation hole 34, which is separated from the first installation hole 32 by a predetermined distance.

The supply valve 30 includes a piston section 38a, which is displaceable in the axial direction inside the first installation hole 32, and which makes sliding contact with the inner circumferential surface of the first installation hole 32, and a valve section 42a connected to the piston section 38a and which is seated on and separated from a valve seat 40a provided in the first installation hole 32. A cylinder chamber 44a, to which the pilot pressure is supplied by the aid of the supplying pilot valve 18, is formed between the end surface of the piston section 38a and the first installation hole 32. The valve section 42a is separated from the valve seat 40a by the piston section 38a, under a pressing action effected by the pilot pressure supplied to the cylinder chamber 44a (valve-open state).

That is, when the supply valve 30 is placed in the valve-open state, the supply port 24 communicates with the ejector 14 via the first installation hole 32. Conversely, when the supply valve 30 is placed in the valve-closed state, communication between the supply port 24 and the ejector 14 is cut off.

On the other hand, the breaker valve 36 includes a piston section 38b, which is displaceable in the axial direction inside the second installation hole 34, and which makes sliding contact with the inner circumferential surface of the second installation hole 34, and a valve section 42b connected to the piston section 38b and which is seated on and separated from a valve seat 40b provided in the second installation hole 34. A cylinder chamber 44b, to which the pilot pressure is supplied by the vacuum-breaking pilot valve 20, is formed between the end surface of the piston section 38b and the second installation hole 34. The valve section 42b is separated from the valve seat 40b by the piston section 38b, under a pressing action effected by the pilot pressure supplied to the cylinder chamber 44b (valve-open state). The supply valve 30 and the breaker valve 36 are arranged substantially in parallel, at intermediate positions in the supply passage 28, so that the supply valve 30 is disposed on the side of the ejector 14.

That is, when the breaker valve 36 is placed in a valve-open state, compressed air flows from the supply passage 28 via the second installation hole 34 to a breaking passage 54 that communicates with a filter 50. When the breaker valve 36 is placed in a valve-closed state, communication between the second installation hole 34 and the filter 50 via the breaking passage 54 is cut off.

A flow rate-adjusting valve 48 is provided in a valve hole 46, which is open on one side surface of the main body section 12, at an upper portion of the main body section 12. The flow rate-adjusting valve 48 is arranged substantially in parallel to the supply port 24. The flow rate-adjusting valve 48 is screw-engaged and displaceable in the axial direction with respect to the valve hole 46.

The valve hole 46 is formed at an intermediate position in the breaking passage 54, which interconnects the second installation hole 34 and a filter hole 52 in which the filter 50 is installed (as described later on). The valve hole 46 communicates with the filter hole 52 and the second installation hole 34. Therefore, when the flow rate-adjusting valve 48 is screwed and displaced in the axial direction, the flow rate of the pressure fluid flowing to the filter hole 52 via the valve hole 46 can be adjusted.

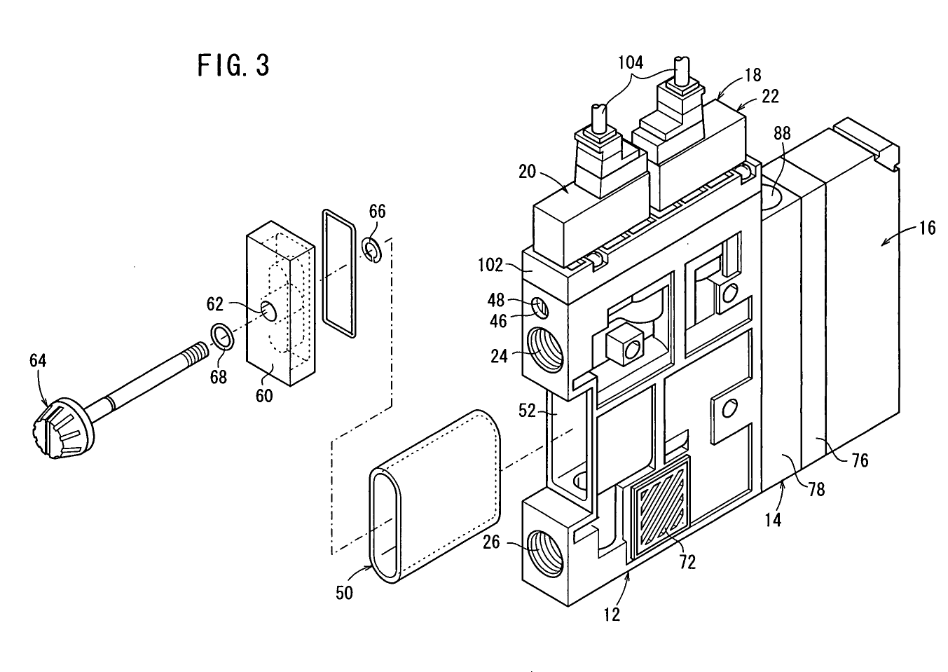

As shown in FIG. 3, the filter 50 is installed in a substantially central portion of the main body section 12. For example, dust and water contained in the air sucked into the main body section 12 are removed by the filter 50, which is disposed between the vacuum port 26 and the ejector 14. The filter 50 is formed of fiber materials composed of, for example, polypropylene or polyethylene, which are wound to provide a cylindrical form having a predetermined width. The filter 50 is installed in the filter hole 52 of the main body section 12.

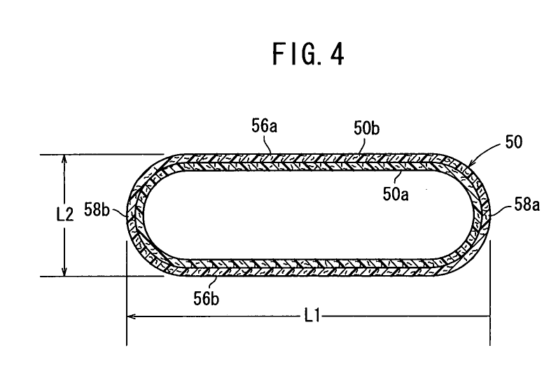

In particular, as shown in FIG. 4, the filter 50 has a two-layered structure, in which an inner circumferential portion and an outer circumferential portion thereof are composed of different materials respectively. The filter 50 is formed such that the thickness of the inner layer (first layer) 50a is substantially equivalent to the thickness of the outer layer (second layer) 50b. Pores in the outer layer 50b are formed so as to be larger than pores in the inner layer 50a. The pores of the filter 50 referred to herein are constituted by gaps, which occur between the fiber material strings when a plurality of fiber materials, having different diameters, are wound to form the filter 50.

The cross-sectional shape of the filter 50 is formed as an elongated circular shape, composed of a pair of flat surface sections 56a, 56b, which are separated from each other by a predetermined distance, and a pair of circular arc sections 58a, 58b which mutually connect the ends of the flat surface sections 56a, 56b respectively. The distance L1 between the pair of circular arc sections 58a, 58b is set, for example, to be about three times the distance L2 between the flat surface sections 56a, 56b (L1≈L2×3). That is, the filter 50 is formed with an elongated circular shape having a narrow widthwise dimension (L2), in which the circular arc sections 58a, 58b are formed at ends of the flat surface sections 56a, 56b which extend a predetermined length respectively.

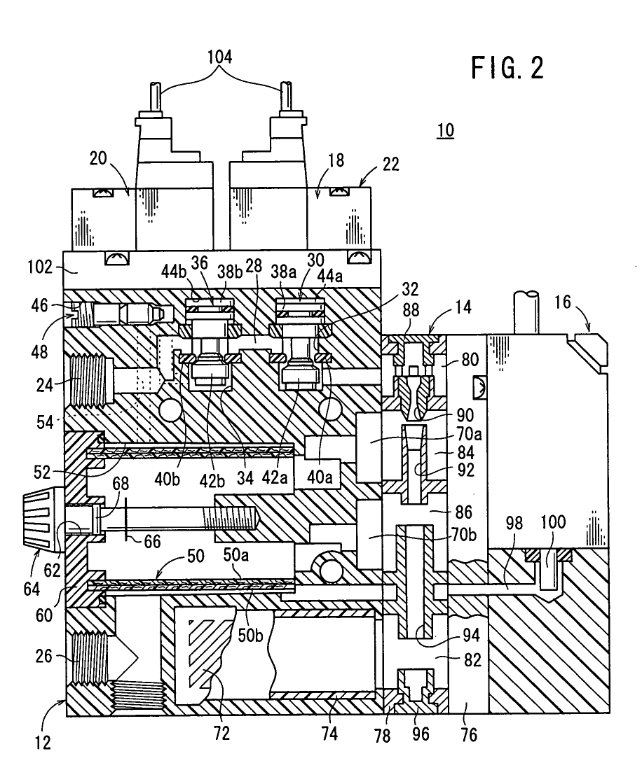

As shown in FIG. 2, one end of the filter 50 engages with a filter cover 60, which is installed on a side surface of the main body section 12, thus closing the filter hole 52. The filter cover 60 is fixed to the main body section 12 by a fastening bolt 64, which is inserted into an insertion hole 62 of the filter cover 60. Accordingly, the filter 50 is interposed between the filter cover 60 and the inner wall of the main body section 12, so that the filter 50 is reliably retained within the main body section 12.

As shown in FIGS. 2 and 3, a disengagement-preventive ring 66 is installed at a substantially central portion in the axial direction of the fastening bolt 64. The disengagement-preventive ring 66 is larger than the diameter of the insertion hole 62. Therefore, the fastening bolt 64 is prevented from becoming disengaged from the filter cover 60. Further, a seal ring 68 composed of an elastic material is inserted onto the fastening bolt 64. When the filter cover 60 is fixed to the main body section 12, the seal ring 68 is fitted inside the insertion hole 62. Therefore, any fluid contained in the filter hole 52 is prevented leaking to the outside via the insertion hole 62.

The filter hole 52 communicates respectively with a pair of recesses 70a, 70b, which are formed at side portions of the main body section 12 to which the ejector 14 is connected. The filter hole 52 communicates with the interior of the ejector 14 via recesses 70a, 70b.

On the other hand, a discharge port 72, which communicates with the ejector 14 for discharging pressure fluid fed from the ejector 14, is formed at a lower portion of the main body section 12. A silencer (silencing section) 74, which reduces an exhaust sound when pressure fluid is discharged from the ejector 14, is provided in the discharge port 72.

The ejector 14 is stacked on one side surface of the main body section 12 on which the pair of recesses 70a, 70b is formed. The ejector 14 is integrally connected to the main body section 12 by a cover member 76 provided at a side portion of the ejector 14.

The ejector 14 includes a casing 78, which is connected to the main body section 12, a supply chamber 80 defined in the casing 78 and which communicates with the supply passage 28, a discharge chamber 82 that communicates with the discharge port 72, first and second diffuser chambers 84, 86 formed between the supply chamber 80 and the discharge chamber 82, and a nozzle 88 that is arranged in the supply chamber 80. The supply chamber 80, the discharge chamber 82, and the first and second diffuser chambers 84, 86 are formed distinctly and independently from each other.

The nozzle 88 is fitted in an upper portion of the casing 78. A first passage 90, which penetrates in the axial direction, is formed in the nozzle 88. The first passage 90 is formed with a tapered shape, in which the diameter thereof gradually increases toward an end disposed adjacent to the first diffuser chamber 84. The first passage 90 communicates with the supply passage 28 of the main body section 12 via the supply chamber 80.

The first and second diffuser chambers 84, 86 are formed at respective positions beneath the nozzle 88, corresponding to the recesses 70a, 70b that are formed on the side of the main body section 12. A second passage 92 is formed between the first diffuser chamber 84 and the second diffuser chamber 86. A third passage 94 is formed in the vertical direction between the second diffuser chamber 86 and the discharge chamber 82.

The second passage 92 is formed at a position opposed to the first passage 90. One end of the second passage 92, which is disposed on a side facing the nozzle 88, is formed with a tapered shape, in which the diameter thereof gradually increases toward the nozzle 88. Accordingly, fluid, which is jetted with great force from the first passage 90 of the nozzle 88, can be captured appropriately by the second passage 92.

The pressure fluid, which is introduced into the second diffuser chamber 86, flows to the discharge chamber 82 via the third passage 94, whereupon the fluid then flows to the discharge port 72. The first, second, and third passages 90, 92, 94 are arranged and aligned substantially along a straight line in the vertical direction of the ejector 14.

On the other hand, a plug 96 is fitted in a lower portion of the casing 78, thereby closing the discharge chamber 82. The plug 96 retains air-tightness in the interior of the casing 78.

The vacuum switch section 16 is connected to the cover member 76, which closes one side portion of the ejector 14. The vacuum switch section 16 includes a communication passage 98 communicating with the interior of the ejector 14 through the cover member 76, a pressure sensor 100 disposed proximate the communication passage 98 and which detects the pressure in the ejector 14, and a control unit (not shown), which is electrically connected to the solenoid-operated valve section 22.

The pressure sensor 100 detects the internal pressure of the ejector 14 through the communication passage 98. An obtained pressure value is output as an output signal to the control unit. Control signals are output from the control unit to the supplying pilot valve 18 and to the vacuum-breaking pilot valve 20, on the basis of the obtained pressure value.

The solenoid-operated valve section 22 is connected to an upper portion of the main body section 12 through a plate 102. The supplying pilot valve 18 and the vacuum-breaking pilot valve 20 are disposed adjacent to each other. The supplying pilot valve 18 and the vacuum-breaking pilot valve 20 are connected to the control unit (not shown) of the vacuum switch section 16, via respective lead wires 104. When the solenoid is magnetically excited on the basis of the control signal supplied from the control unit, an unillustrated valve plug is subjected to opening and closing operations.

The pressure fluid, which serves as a pilot pressure, is supplied from an unillustrated pressure fluid supply source to the supplying pilot valve 18. The pilot pressure is supplied to the first installation hole 32 via a pilot passage (not shown) by opening/closing the valve plug.

The valve section 42a of the supply valve 30, which is disposed in the first installation hole 32, is displaced in an axial direction in accordance with the pilot pressure supplied to the cylinder chamber 44a of the first installation hole 32. The valve section 42a is seated on or separated from the valve seat 40a, thus switching between respective valve-open and valve-closed states.

The pressure fluid serving as the pilot pressure is supplied from the pressure fluid supply source (not shown) to the vacuum-breaking pilot valve 20, in the same manner as in the supplying pilot valve 18. The pilot pressure is supplied to the second installation hole 34 via a pilot passage (not shown) by opening/closing an unillustrated valve plug.

The valve section 42b of the breaker valve 36, which is disposed in the second installation hole 34, is displaced in an axial direction in accordance with the pilot pressure supplied to the cylinder chamber 44b of the second installation hole 34. The valve section 42b is seated on or separated from the valve seat 40b, thus switching between respective valve-open and valve-closed states.

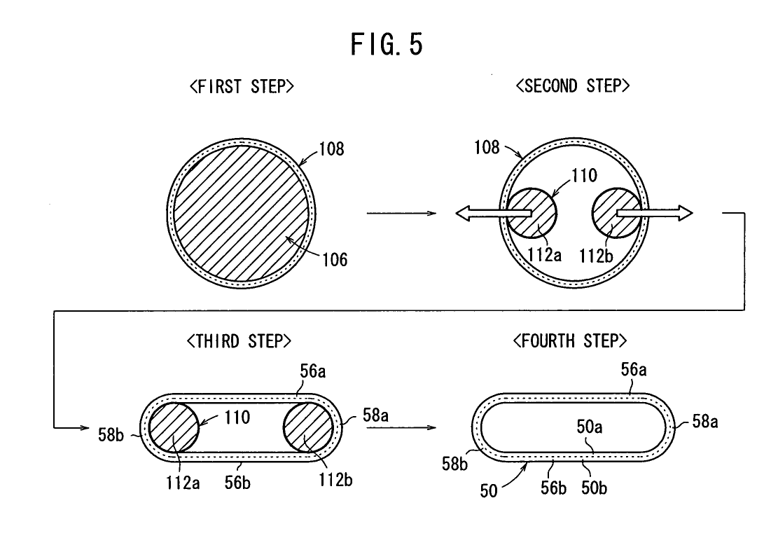

The vacuum unit 10 according to the embodiment of the present invention is basically constructed as described above. Next, detailed explanations shall be given, with reference to FIG. 5, concerning a method for producing the filter 50 contained in the vacuum unit 10.

At first, fiber materials (for example, thermo-bonding or thermal adhesive composite fibers), which constitute the filter 50, are wound at a predetermined thickness around a columnar die 106, which has a perfect circular cross section. The filter 50 is composed of two layers, comprising a plurality of fiber materials, to provide pores having different sizes. Therefore, the first fiber material is wound at a predetermined thickness around the outer circumferential surface of the die 106. After that, the second fiber material, which has a larger fiber diameter, thus producing larger pores as compared to the pores of the wound first fiber material, is wound at a predetermined thickness so that the first fiber material is covered therewith. Stated otherwise, the applied first fiber material has a fiber diameter that is smaller than the fiber diameter of the second fiber material.

A cylindrical member 108 is formed, in which the two layers formed by the first and second fiber materials are wound around the outer circumferential surface of the die 106 at a substantially constant width (see the first step shown in FIG. 5). In other words, the first fiber material forms an inner layer on the surface of the die 106, and the second fiber material forms an outer layer, which is formed over an outer circumferential surface of the inner layer.

In this arrangement, the fiber diameter of the second fiber material making up the outer layer (second layer) 50b is larger than the fiber diameter of the first fiber material making up the inner layer (first layer) 50a. Therefore, gaps (pores) between the fiber material strings are larger in the outer layer 50b as compared with the inner layer 50a. That is, the pores of the outer layer 50b are formed to be larger than the pores of the inner layer 50a.

Subsequently, the die 106 is extracted from the cylindrical member 108, and a forming jig 110 is inserted into the cylindrical member 108. The forming jig 110 has a pair of shaft sections 112a, 112b. The shaft sections 112a, 112b are freely capable of approaching one another and separating from each other. Further, the diameters of the shaft sections 112a, 112b are smaller than the diameter of the die 106 respectively.

The pair of shaft sections 112a, 112b are displaced in directions to separate away from each other, while the shaft sections 112a, 112b abut respectively against the inner circumferential surface of the cylindrical member 108 (see the second step shown in FIG. 5). The shaft sections 112a, 112b are further displaced in directions to separate from each other, and accordingly, the cylindrical member 108 is deformed by the shaft sections 112a, 112b such that the cylindrical member 108 is elongated substantially in the horizontal direction starting from the base points of abutment against the shaft sections 112a, 112b.

As a result, the cylindrical member 108 is deformed by the shaft sections 112a, 112b into an elongated circular form, having flat surface sections 56a, 56b, which are substantially parallel to one another, and a pair of circular arc sections 58a, 58b, which have substantially the same radius as the radius of the shaft sections 112a, 112b, at the ends of the flat surface sections 56a, 56b (see the third step shown in FIG. 5). During this procedure, the displacement speeds at which the shaft sections 112a, 112b separate from each other are controlled so that the displacement speeds of the shaft sections 112a, 112b are substantially equivalent to one another.

Finally, a heat treatment (for example, a sintering treatment) is applied to the cylindrical member 108 at a predetermined temperature (for example, 150° C.) for a predetermined period of time (for example, 15 minutes) during a state in which the cylindrical member 108 has been deformed in the elongated circular cross section by the pair of shaft sections 112a, 112b. The cylindrical member 108 is formed with the cross section thereof being permanently deformed in an elongated circular form. Therefore, when the shaft sections 112a, 112b are disengaged from the cylindrical member 108, the filter 50 is produced as a deformed cylindrical member 108 (see the fourth step shown in FIG. 5).

The filter 50, having the substantially elongated circular cross section, can be produced as described above by deforming the cylindrical member 108 wound with fiber materials by means of the forming jig 110, and then applying a heat treatment to the cylindrical member 108. As a result, a thinner type of filter 50 can be manufactured, as compared to the case in which the cylindrical member has a perfectly circular cross section.

For producing the elongated circular filter 50 described above, the following production method has previously been adopted. That is, a die, having an elongated circular cross section corresponding to the shape of the filter 50, is produced, and a fiber material is wound around the circumferential surface of the die. However, in this case, several dies, which correspond to shapes of various filters 50, are required respectively. Therefore, a problem arises in that the cost required for the dies increases. Contrasted with the former production method, in the case of the filter 50 according to the embodiment of the present invention, the fiber materials are previously wound to produce the cylindrical member 108 using the perfectly circular die 106 which can be produced inexpensively. After that, the cylindrical member 108 is deformed into an elongated circular form by means of the forming jig 110. Therefore, the filter 50 according to the embodiment of the present invention can be produced inexpensively as compared with a conventional filter 50.

Further, the filter 50 has a two-layered structure having different pore sizes. Accordingly, a plurality of sizes of the pores can be established for the filter 50, as compared with other conventional filters having hitherto been formed with a single layer. That is, in the case of the conventional filter, pores can be established having only a single pore size. Therefore, it has been difficult to design pores having other than a single predetermined value, in order to avoid clogging caused by dust or the like.

By contrast, in the filter 50 according to the embodiment of the present invention, a two-layered structure is provided, in which the inner layer 50a and the outer layer 50b are composed of two fiber materials having different fiber diameters. The pores of the outer layer 50b can be comparatively large, whereas the pores of the inner layer 50a can be smaller as compared with the pores of the conventional filter. Therefore, the porosity or percentage of voids of the outer layer 50b of the filter 50 can be increased, compared to the conventional filter, thereby avoiding clogging by dust or the like. Thus, it is possible to improve the durability of the filter 50. Simultaneously, dust or the like can be removed more reliably by decreasing the porosity of the inner layer 50a. Porosity is defined as the ratio of the pores with respect to the surface area of the filter 50.

Next, an explanation shall be given concerning operations, functions, and effects of the vacuum unit 10, which contains the filter 50 produced as described above.

When an unillustrated workpiece is transported, a control signal is output to the supplying pilot valve 18 by the control unit (not shown) contained in the vacuum switch section 16. Pilot pressure is supplied from the supplying pilot valve 18 to the first installation hole 32. The piston section 38a is pressed downwardly under a pressing action effected by the pilot pressure, and the valve section 42a of the supply valve 30 separates from the valve seat 40a. As a result, the supply valve 30 is placed in an ON state (valve-open state). In this situation, the breaker valve 36 is in a valve-closed state. Therefore, pressure fluid does not flow to the breaking passage 54.

Accordingly, pressure fluid is supplied from the supply port 24 to the ejector 14 via the supply passage 28 of the main body section 12. The pressure fluid passes sequentially through the first to third passages 90, 92 and 94, and thus a negative pressure is generated. The negative pressure fluid is supplied from the ejector 14 to the vacuum port 26 via the recesses 70a, 70b and the filter hole 52. The negative pressure fluid is supplied to the suction pad (not shown), which is connected to the vacuum port 26.

During this process, the negative pressure fluid flows through the inside of the filter hole 52 and passes through the filter 50. Accordingly, dust, water, or the like contained in the negative pressure fluid is removed. In particular, the pressure fluid flows from the outside to the inside of the filter 50. Therefore, at first, large dust particles or the like are removed by the outer layer 50b when the negative pressure fluid passes through the outer layer 50b. Any remaining dust or the like is removed when the negative pressure fluid passes through the inner layer 50a, which has pores smaller than those of the outer layer 50b. Accordingly, dust or the like can be removed by the filter 50 in a stepwise manner. Therefore, it is possible to reduce clogging, which might otherwise be caused in the filter 50.

When the unillustrated suction pad attracts a workpiece (not shown) under a negative pressure action of the supplied negative pressure fluid, and the negative pressure generated by the ejector 14 is enhanced, then enhancement of the negative pressure is detected by the pressure sensor 100, which communicates with the ejector 14. When the pressure exceeds a previously established preset pressure, an output signal is output to the control unit, and as a result, the control unit confirms that the workpiece has been reliably sucked and attracted by the suction pad.

Next, an explanation shall be given concerning a procedure in which attraction of the workpiece effected by the suction pad is maintained, and then supply of negative pressure fluid is canceled after the workpiece has been moved using an unillustrated robot or the like, so that the workpiece can be disengaged at a predetermined position.

A stop signal is output from an unillustrated control unit to the supplying pilot valve 18, whereupon operation of the supplying pilot valve 18 is stopped. Accordingly, the supply valve 30 operates in cooperation with the supplying pilot valve 18, producing an OFF state (valve-closed state). As a result, supply of pressure fluid, having been supplied from the supply port 24 to the ejector 14, is stopped. Accordingly, supply of negative pressure fluid from the ejector 14 via the vacuum port 26 to the suction pad (not shown) is also stopped.

On the other hand, when the control signal is output from the control unit to the vacuum-breaking pilot valve 20 in order to operate the vacuum-breaking pilot valve 20, pilot pressure is supplied to the breaker valve 36. The pilot pressure presses the piston section 38b downward. Accordingly, the valve section 42b separates from the valve seat 40b, and the breaker valve 36 is placed in an ON state (valve-open state). As a result, pressure fluid supplied from the supply port 24 flows to the breaking passage 54 via the second installation hole 34. The supply valve 30 is in a valve-closed state, and hence flow of pressure fluid to the ejector 14 is cut off.

The pressure fluid flows from the breaking passage 54 to the filter hole 52, whereupon the pressure fluid is supplied to the suction pad (not shown) via the vacuum port 26. As a result, the workpiece is released from being attracted by the suction pad. During this process, dust or the like contained in the pressure fluid is appropriately removed by the filter 50, in the same manner as in the process in which negative pressure fluid is supplied to the vacuum port 26. The flow rate of pressure fluid flowing through the breaking passage 54 can be arbitrarily adjusted by the flow rate-adjusting valve 48.

When the workpiece is disengaged from the suction pad, the interior of the ejector 14 is changed from the negative pressure state and placed at atmospheric pressure. Therefore, when the pressure in the ejector 14 is detected by the pressure sensor 100, disengagement of the workpiece from the suction pad is confirmed.

As described above, the elongated circular filter 50 composed of fiber materials is used in this embodiment. Accordingly, the vacuum unit 10 can be made thinner by suppressing the widthwise dimension W (see FIG. 1) of the main body section 12 which contains the filter 50. Therefore, a more compact size can be achieved by reducing the widthwise dimension of the vacuum unit 10.

The silencer 74, which reduces the exhaust sound generated when the pressure fluid is discharged, can be arranged integrally at a lower portion of the main body section 12. Therefore, it is possible to reduce the number of parts, and it is further possible to improve assembly operations, as compared with a conventional vacuum unit in which a distinct member retaining a silencer is assembled on the main body section 12.

Although certain preferred embodiments of the present invention have been shown and described in detail, it should be understood that various changes and modifications may be made therein without departing from the scope of the appended claims.

What is claimed is:

1. A vacuum unit comprising:
a main body section, which includes a pressure fluid-supplying port and a vacuum port, and which includes a filter for removing dust contained in a pressure fluid supplied from said pressure fluid-supplying port, and a silencing section for reducing an exhaust sound produced when said pressure fluid is discharged to outside;
a vacuum-generating mechanism, which generates a negative pressure under action of said pressure fluid;
a solenoid-operated valve section, which is composed of a vacuum-breaking directional control valve and a supplying directional control valve, for switching a pressure of said pressure fluid supplied to said vacuum port between a state of negative pressure and a state of positive pressure; and
a vacuum switch section, which is disposed between said vacuum-generating mechanism and said vacuum port, and which switches said vacuum-breaking directional control valve from an OFF state to an ON state when said negative pressure arrives at a predetermined value,
wherein said filter includes a plurality of layers composed of fiber materials having different material qualities, and a cross-sectional shape of said filter is formed in an elongated circular shape having a pair of circular arc sections.

2. The vacuum unit according to claim 1, wherein pores, which are formed in an inner layer of said plurality of layers of said filter, are smaller than pores of an outer layer formed outside of said inner layer.

3. The vacuum unit according to claim 2, wherein said filter has a substantially elongated circular cross section having said pair of circular arc sections, and flat surface sections which mutually connect one circular arc section and another circular arc section.

4. The vacuum unit according to claim 3, wherein said filter is designed such that a distance between said pair of circular arc sections is larger than a distance between said flat surface sections.

5. The vacuum unit according to claim 4, wherein said filter is installed such that said flat surface sections are substantially in parallel to a vertical direction of said main body section.

6. The vacuum unit according to claim 1, wherein said silencing section is accommodated within said main body section.

7. A method for producing a filter for use in a vacuum unit, said vacuum unit generating a negative pressure by a vacuum-generating mechanism under an action of a pressure fluid supplied from a pressure fluid-supplying port and supplying said negative pressure to a vacuum port, said filter being installed in said vacuum unit to remove dust contained in said pressure fluid, the method for producing said filter comprising the steps of:
winding a first fiber material around a circumferential surface of a die having a perfect circular cross section to form a first layer;
winding a second fiber material around an outer circumferential surface of said first layer to form a cylindrical member in which said second layer is stacked on said outer circumferential surface of said first layer, said second fiber material having a diameter larger than that of said first fiber material;
disengaging said die from said cylindrical member composed of said first and second layers and inserting a forming jig into said cylindrical member, said forming jig having a pair of shaft sections;
displacing said shaft sections in directions to separate from each other while abutting against inner circumferential surface portions of said first layer disposed on an inner circumferential side of said cylindrical member, so that said cylindrical member is deformed to have an elongated circular cross section; and
performing a heat treatment in a state in which said deformed cylindrical member is retained by said pair of shaft sections.

8. The method for producing said filter for use in said vacuum unit according to claim 7, wherein said heat treatment for said cylindrical member comprises a sintering treatment.
